(19) United States
(12) Patent Application Publication
(10) Pub. No.: US 2014/0205988 A1
(43) Pub. Date: Jul. 24, 2014

(54) SYSTEM, SOFTWARE AND ASSOCIATED METHOD OF USE THEREOF FOR THE TRANSFER OF INFORMATION BETWEEN A MODERATOR ADN RECIPIENTS

(71) Applicants: Paul Joseph Chang, Chicago, IL (US); Brian Joseph Kalbfleisch, Lombard, IL (US); Steven Thomas Drew, Gurnee, IL (US); Christopher Daniel Carr, Glen Ellyn, IL (US); David Richard Pede, Lemont, IL (US)

(72) Inventors: Paul Joseph Chang, Chicago, IL (US); Brian Joseph Kalbfleisch, Lombard, IL (US); Steven Thomas Drew, Gurnee, IL (US); Christopher Daniel Carr, Glen Ellyn, IL (US); David Richard Pede, Lemont, IL (US)

(73) Assignee: Radiological Society of North America, Oak Brook, IL (US)

(21) Appl. No.: 13/748,828

(22) Filed: Jan. 24, 2013

(51) Int. Cl. G09B 5/00

(52) U.S. Cl. CPC G09B 5/00
USPC 434/350

(57) ABSTRACT

The present invention relates to a web-based computer system, a web-based computer software, and a method of use thereof for the transfer of information between a moderator and a plurality of recipients either in a face-to-face environment or in a remote environment, and more specifically the use of a moderator station, a projector display, and a plurality of user web-enabled devices connected to a network in a group and team competitive environment.

### FIELD OF THE INVENTION

The present invention relates to a web-based computer system, a web-based computer software, and a method of use thereof for the transfer of information between a moderator and a plurality of recipients either in a face-to-face environment or in a remote environment, and more specifically the use of a moderator station, a projector display, and a plurality of user web-enabled devices connected to a network in a group and team competitive environment.

### BACKGROUND

The internet and other information networks have, over the last decade, greatly modified the way humans interact, communicate, teach, and learn. Tools are constantly being developed to help teachers, lecturers, authors, and orators better communicate information to recipients, but while the growth of the Internet has been exponential over the last decade, classroom dynamics or remote classroom dynamics, and the presentations at seminars have strangely been impervious to change and integration of new technology. In a live face-to-face context by itself or as part of a broadcasted presentation, a person stands in front of an audience or a camera and talks to a group of people ultimately there to listen and learn. Generally, a presentation is displayed on a blackboard, a board, or some type of digital media and the audience takes notes on a paper, for example a paper version of the presentation.

Early on at the time when computer networks were first developed, it was believed that remote teaching over the internet or other networks would become a preferred mode of communication and become the prevalent method of communication. Hindsight shows us that remote transfers of live information over networks have not met a great level of success. Some figured that by filming and broadcasting a single performance from an amazingly gifted speaker, there would be no need for ordinary teachers to enter classrooms and teach. Time tells quite a different story. Online universities struggle with their own growth as students prefer in-class teaching. The same way, seminars who offer good live speakers remain popular and attendance at live seminars remains high. The introduction of technology in the context of the transfer of information between individuals in a face-to-face environment or a partly remote environment is not simple and has in fact proven extremely difficult.

One fact remains, retention of information and learning is function of the motivation and the concentration of individuals in the room or listening to any broadcast; individuals seem to prefer a bad live or individual teacher over simply watching a recording for a wide mass audience of the most wonderful one. Each time a interface, for example a camera capable of recording a broadcast comes in place between a presenter/teacher and his or her listeners/students audience, the motivation and concentration of the audience drops and the effectiveness of the transfer of information drops alongside.

Something must be said about the advantage of group dynamics unhindered by technology. Humans find an intangible comfort in being in the company of others. A movie going experience is enjoyed in a packed room and is preferred over watching the same movie in the comfort of one's home even on a large television even for a fraction of the price. Humans love to attend live sports events even if high definition broadcastings include more camera angles, better views, and greater personal comfort at lower cost. It is important to understand this social behavior when any system is designed to be inserted within the information transmission process and act as technology layer in this context of transfer of technology. Many inventions exists and have been developed over the years to help with the transfer of technology between a speaker and his or her audience for example in a classroom environment, none have been truly successful to a point where the dynamics have changed.

For example, U.S. Patent Publication U.S. 2003/0198936 describes a real-time learning assessment method for interactive teaching conducted by means of portable electronic devices. In this system from the prior art shown as FIG. 1, a teaching Personal Digital Assistant (PDA) is linked to a series of learning PDAs. A test mode is launched who in turn runs a program on each learning PDA. A batch of proposed answers from each student is entered on a device as a whole for the entire test, one answer to each of a plurality of questions. The results are then sent back to the teaching PDA only once the exam is over. The teaching PDA is then able to compile information and send back test scores using the same wireless link. This early system also discloses how a teacher uses the teaching PDA to receive questions from the class participants, or a notice that a question of a student requires attention.

This system as a whole only introduces technology where none is needed and slows down the process of learning. The system is labor intensive as it relies on the existence and connection to a Local Area Network (LAN) as well as the purchase by students and teachers of specific equipment installed with specific software to implement the system. Schools must make investments, train LAN technicians on the equipment and ask a teacher to program tests using this difficult to read interface. Not surprisingly, these systems while at first a nice change in a learning routine, quickly become a burden and are set aside by the teacher.

A slightly different system is shown in U.S. Patent Publication 2004/0214251 as an automatic and interactive computer teaching system. As shown in the prior art illustration at FIG. 2 from this prior art, an interactive learning software is installed in a standalone computer equipped with a multi PDA connection box. A teacher enables one PDA to reply to a question displayed on each of the PDAs. This system is burdensome and it is unclear how students and teachers benefit from having to operate this equipment as an improvement to live classroom participation. Once again, this system requires the purchase of dedicated PDAs by all students, the management of connection boxes, and the learning and programming of testing software. Both of these existing systems are burdensome and do not help a teacher improve the overall efficiency of teaching either in a face to face classroom environment, a partial classroom environment, or a remote environment.

In the context of teaching, education, lectures, or even passive transfer of information, technology advances who seem beneficial often turn out to be impractical, burdensome and an impediment of an already efficient learning environment. What is needed is a system and associated method that uses technology very efficiently in a very unique way to enhance an efficient process already in place. The system must be ‘invisible’ to implement, to use, and more importantly must not interfere with the connection between the teacher/orator and the students/participants. What is also needed is a quasi-intuitive way to draw a greater amount of transfer of knowledge between a presenter/teacher and participants/students at low cost, without the need for a bulky and technologically advanced system that requires maintenance, upkeep, and specific knowledge to operate.

What is also needed is a system and method of use thereof that allows for better immediate assessment of the retention of information to help stimulate a student/participant who may be losing focus while wrongfully believing that retention is occurring when in fact it is not.

### SUMMARY

The present invention relates to a network enabled computer system, a network-based computer software for use in connection with the network enabled computer system, and a method of use thereof for the transfer of information between a moderator and a plurality of recipients in a face-to-face environment or in a remote or partly remote environment. In the system, a presentation forming for example a series of sequential questions are programmed into an interface for use in a face-to-face setting or any other remote setting. A moderator tasked with transferring information to listeners in proximity or over a network uses a large display such as a plasma television connected to the network to display questions, data, or group answers. The recipients of the information use their own hand held devices with a connection to a network to connect individually or in teams to the online interface and receive at least a portion of the information displayed on the room display and are then capable of interactive answer of questions presented, scrolled, or displayed. A gaming component is also added to help further enhance motivation of the different users of the platform. The unique combination of these access tools, the ease in implementation of using the devices owned by the recipients greatly reduce the need for the purchase or maintenance of equipment. This system can be used intuitively by moderators and recipients at any location where a display is found to help with teaching, learning, or even assessment (self or by the moderator) of the participants.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 an illustration from the prior art.

FIG. 2 is another illustration from the prior art.

FIG. 3 is a schematic representation a portable and interactive competitive environment according to an embodiment of the present invention.

FIG. 4 is a schematic representation of the different physical devices part of the portable and interactive competitive environment as shown at FIG. 3.

FIG. 5 is a block diagram of the different portion of the software implemented as part of the portable and interactive competitive environment as shown at FIG. 3.

FIG. 6 is a block diagram of the different displays at the user device used as part of the portable and interactive competitive environment of FIG. 3.

FIG. 7 is a flow chart describing the steps associated with the creation of a presentation for used within the portable and interactive competitive environment of FIG. 3.

FIG. 8 is a flow chart describing a method of use of the portable and interactive competitive environment of FIG. 3.

FIG. 9 is a general illustration of a computer, a portable computer, or a hand held device with its different components.

FIG. 10 is a view of the control panel as seen by a moderator on his moderator station.

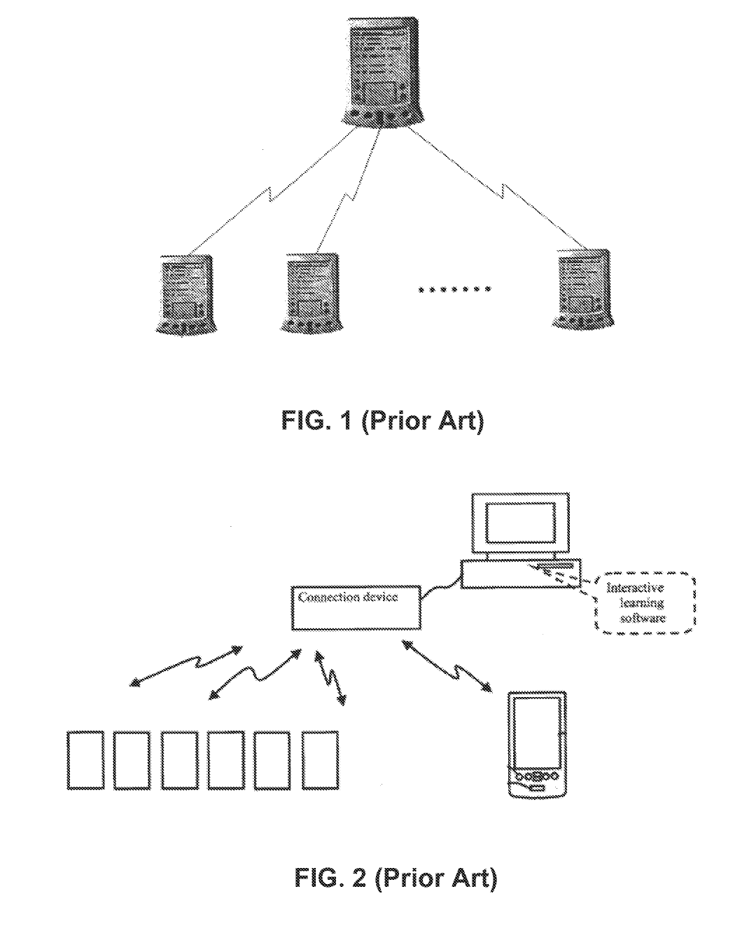

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

The inventor of this system, software and method of use thereof has invented a computer system arming himself with a deep understanding that humans who enjoy an environment such as learning in a classroom, teaching or presenting seminar information, will seek an environment where learning and the transfer of information in such an environment is optimized (e.g. students are drawn to classes where learning is easy, and retention rates are good). Therefore, an environment created through the use of this system, software, and method of use is optimized and charged with more stimuli whether an emotional, musical, or societal caused by the direct or indirect interaction of the presenter/teacher with the participant, or the environment is made more stimulating through a slightly competitive environment that takes on flavors of a game, or a mild competition.

Attendance at a seminar can be enhanced, for example, by a better lit room, better sound quality, and a highly charged and motivated teacher. Learning can also be improved by providing a stimulant like tea or coffee or even creating a more dynamic and colorful presentation. The principle behind this invention is inspired from observations and research in the medical field that prove that patients react favorably to therapy or treatment if their emotional well-being is taken into consideration. The same is true of humans in post traumatic stress or under hypnosis who retain more information on a deeper level because of their recently experienced life events.

The inventor has also discovered that comparative analysis is a useful and powerful tool to a student/learner to help remember and assimilate concepts and information. Wrong answers or mistaken beliefs if immediately challenged can be used to enhance learning and will result in a better self assessment of a learner/student/participant. For example, in the classical mode of learning, a test is submitted and attendees are asked questions and provide their best answers. Sometime later, they receive the result and few students have the level of motivation needed to self assess their own performances. Because of this lag in time, the chances of correcting a misunderstanding is lower than if action is taken immediately after the wrong answer is entered. Some teachers try to lower the time between answer and assessment by correcting openly in a class the exam, for example by exchanging copies between students, but this process is open to several problems. Further, a teacher who is given a tool and observes immediately a student fumble on a question can immediately correct his method of teaching thus enhancing the overall transfer of information.

To the inventor, the use of a group dynamic can also be helpful in many aspects to lessen the trauma of the correction of wrong answers. Students rarely understand that some questions elude a large proportion of class participants, and lose motivation by thinking their performances are inferior to the average when in fact it is not. For example, a person who has answered in error a question when instantly shown that 25% of peers are also in error, this person is more likely to react favorably to the corrective stimuli, listen and remember the correct answer.

One other advantage to group dynamic is to create some mild level of competitive environment merging people into groups and awarding these groups points for each correct answer. As a consequence of this environmental stimulus, some competitive individuals will ‘play along’ and position themselves in an open and receptive mindset increasing their level of concentration and learning to beat others and not to better themselves. Other less competitive individuals may be placed in a receptive mindset because of their desire to please a team in which they belong, or because they are given a key role as part of the team. The creation of groups and teams within any number of participants enhances the capacity to learn and retain information.

Within this disclosure, the term student, participant, attendee, or any person in a role to learn is considered interchangeable and to include in addition to its ordinary understanding the concept of a person that ultimately receives information. Within this disclosure, the term teacher, presenter, also is written to include in addition to its ordinary meaning the general concept of a person having as a task to convey information to a person receiving information.

In one embodiment, the inventor works in the field of radiology where in addition to basic encyclopedic medical knowledge conveyed, this field centers around the analysis of complex scanned images of the human body. Ultimately, images must be diagnosed and analyzed and diagnostics must be rendered. Doctors must (a) discover an anomaly, (b) diagnose it, or (c) confirm that no anomaly is found. The system described herein helps with the detection, the identification, and the conclusion by a practitioner for any given image. The system must also allow for these steps to be performed in a way that mimics the actual practice in the field to further help with leaning and retention. For example, this system can be used to help musicians learn from sound tracks, or engineers learn by watching three dimensional structures in rotation. While one technology is described as part of this disclosure, what is contemplated is the use of this system, software, and method of use thereof in any possible technology and field where the transfer of information is contemplated.

In the field of medicine, practitioners are also generally bombarded with information and can quickly lose focus and interest when they are at a seminar or given new instructions. For this reason, the system provides for incentives such as a gaming element, ribbons, awards, or even the publication of positive results and pictures to help motivate and learn.

Hardware

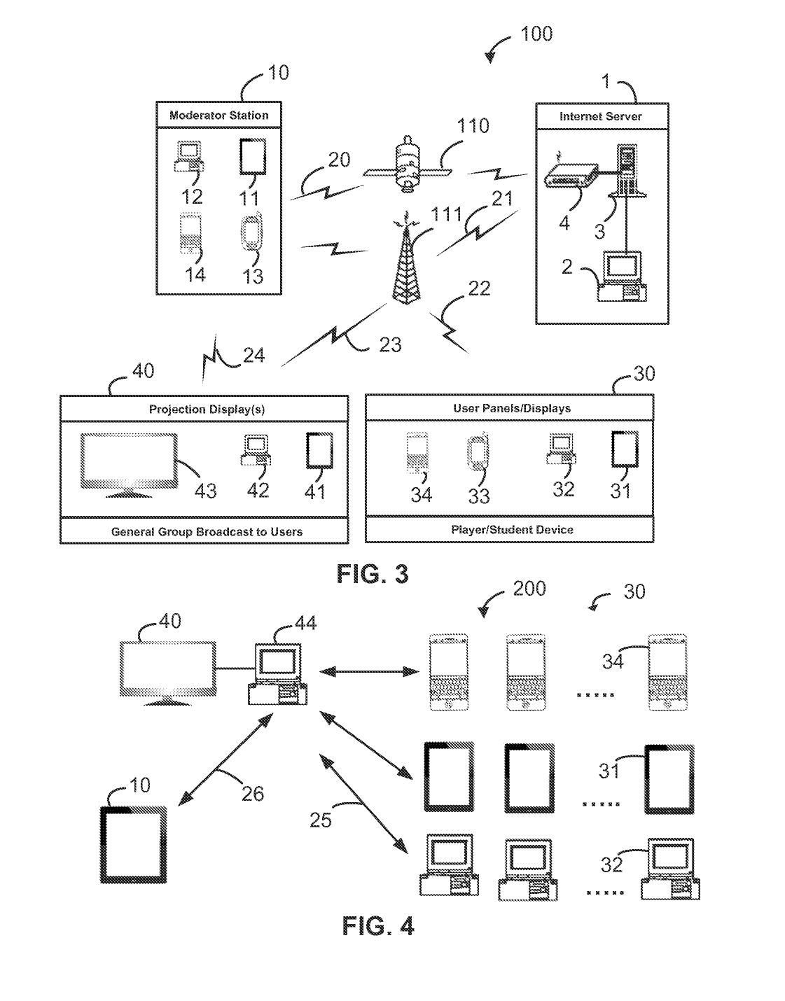

FIG. 3 shows hardware associated with the computer system used as part of the new system for the transfer of information from a moderator to recipients. The system 100 includes a server 1 such as an internet server, a Local Area Network (LAN), a web-enabled server also known as an HTTP server having a hardware such as a memory 3 for storing database information and software. In turn, this server 3 connected to a user interface 2 for access and entry of at least a portion of the information on the server 3. The internet server 1 is connected to an outside network via hardware 4 such as a modem. The outside network is illustrated generally by a series of arrows 20, 21, 22, and 23 between the different elements in the network including different intermediary communication linking devices such as relay stations 111, satellites 110, or even computers (not shown) for the transfer of information from the different elements in the network such as different web servers and web enabled devices 10, 40, and 30.

While one type of network is shown, what is contemplated is the use of wireless technology or any other communication network, including internal networks, other intranets using different protocols of communication, including but not limited to military systems or internal wireless networks like networks set up in academic contexts.

A second element of the system 100, the first piece in the location where the transfer of information occurs, is a control panel 10 such as a portable laptop or computer 12, a pad without a keyboard such as an iPad 11 from the Apple® Corporation, a handheld device 13 or even a web-enabled iPhone 14 from also from the Apple® Corporation used by a moderator, such as a teacher in class as he/she moves about the room and keeps the important direct link of communication with the students. In the context of a seminar, the speaker or an assistant holds the control panel 10 and can move in the room to receive information as to how each question is answered as the participants enter the information into the system 100. The control panel 10 is connected 20, 21 to the internet server 1 via the network and the software allows for the exchange of data between the server 1 and the control panel 10.

A third piece of hardware of the system 100, the second piece in the location where the transfer of information occurs, is at least one projection display 40 such as a large screen 43, a tablet 41 or even a computer 42 with a display used to broadcast selected information to the different people in vicinity of the display 40. In one preferred embodiment, a large plasma television or a projector screen is used. The moderator holding the station with a control panel 10 walks around a room and pushes buttons on the control panel described below to change the display shown to users located in the room over the projection display 40 or uses the control panel 10 to interact with people outside of the room capable of viewing the moderator and the display 40. For example, a teacher may use the control panel 10 to display data such as an X-Ray picture of a human part placed as part of the software presentation with an upcoming question. The teacher talks about the picture, and only once satisfied that students are ready to answer a multiple choice question, pushes a button on the control panel 10 to change both the display on the projection display 40 as shown at FIG. 10 and on the screen of the small devices 30 held by the students. The teacher can also elect to keep the large version of the X-Ray picture on the display 40 to help students with their analysis and diagnostic of the problem as they proceed with their answer.

The fourth and last piece of hardware in this system 100 is a plurality of devices 30 used by users such as conference attendees, students, or other person who desires to be the recipient of information from a moderator or other person using the system 100. These devices 30 such as web-enabled phones 33, portable computers 31 including pads, or iPhones® are now commonly owned by individuals and it may now be assumed that any participant to a seminar, a class, or other session be asked to bring a personal device to log directly into the system 100 from an internet browser interface built-in the device 30 through a web-portal.

FIG. 4 shows the portion of the system 100 that is located in the room or in the space where the system operates and operates using a software layer located on a remote server 1. The projection display 40 can be attached to a computer 44 for direct room or internet interaction between the different elements. The system may include multiple devices 30 from different types 34, 31, or 32 for the display of information. To an observer, it appears that the moderator station 10 sends information 26 to the computer 44 for display over the projection display 40 who in turn send information 25 to the different user devices 30. In fact, in one contemplated embodiment, all of the devices are connected to a network who coordinates the display of information remotely as shown at FIG. 3.

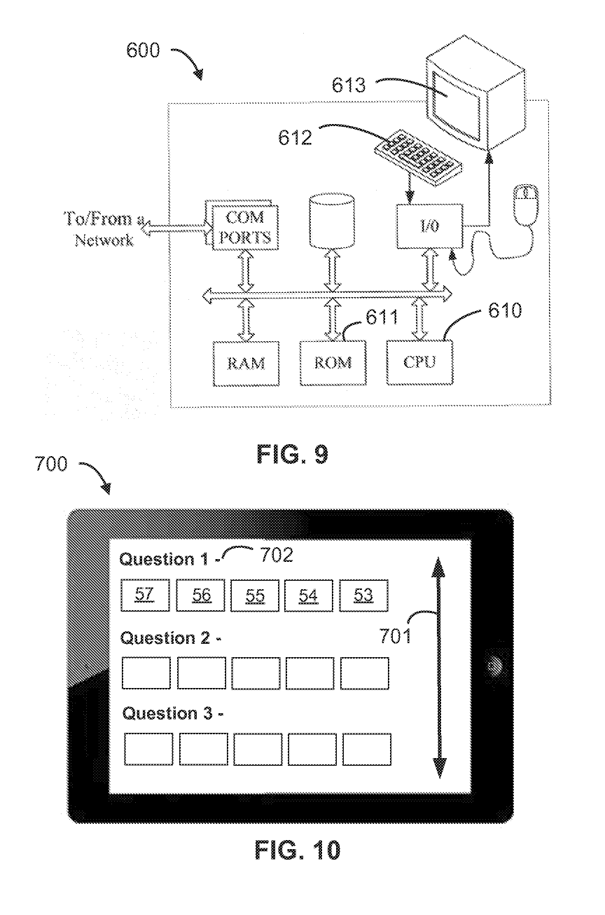

What is shown is a computer system 100 used by a moderator (not shown) and a plurality of information recipients (not shown) such as a teacher and his students, or a presenter and his audience, to aid with the transfer of information from the moderator to the recipients. In one embodiment, the transfer of information is teaching. The moderator is defined herein as a single person or a plurality of people operating a moderator station 10 where a control panel is displayed and used as part of the system 100. The moderator station 10 as most computers 600 shown generally at FIG. 9, includes a processor 610 such as a moderator processor with a memory 611 when in the moderator station 10 called the moderator memory, an interface 612, when in the moderator station 10 called the moderator interface, and a display 613 called the moderator display each connected to the moderator processor 610 for executing a control panel 10 on the moderator display 613 as part of a presentation software 200 located on a remote server 1 via a network as shown at FIG. 3, and for entry of at least a command into the software as described with greater detail below via the moderator interface 612.

The system 100 also includes a projection display 40 connected to the presentation software via the network shown at FIG. 3 for displaying a portion of a general presentation, where the portion displayed of the general presentation is controlled by the command entered in the moderator interface 612. Also, each of a plurality of users has a device 30 as shown at FIG. 4 each also with at least a processor 610 called the user processor when used on the user device 30, a memory 611 called a user memory when used in the user device 30 connected to the user processor 610, an interface 612 referred to as a use interface when used on the user device 30, and a display 613, wherein each device 30 as shown at FIG. 4 is connected to the presentation software for displaying information from the general presentation as controlled by the command entered in the moderator interface, and at least one network enabled server 1 connected to the network as shown at FIG. 3 with also a processor 610 called the server processor when used on the server 1, and a memory 611 also called a server memory for executing the presentation software.

Software

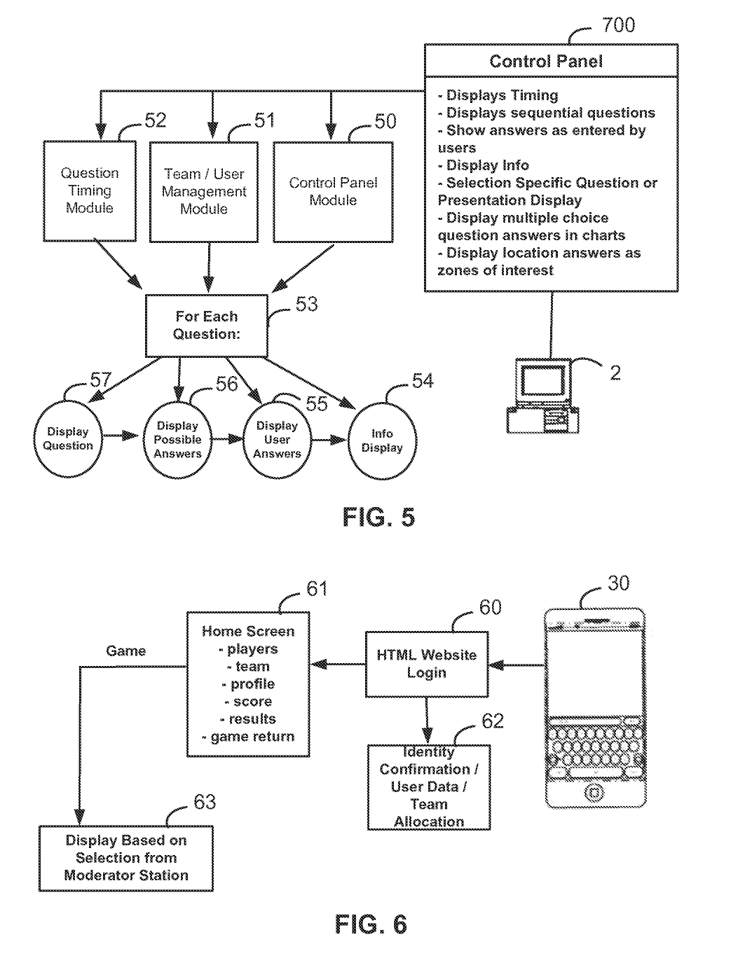

While FIGS. 3-4, and 9 shows the hardware component of the system 100, the software portion of this system 100 is shown in part at FIGS. 5-6, and 10. One of ordinary skill will recognize how software in this field is merged and operates as part of hardware. FIG. 5 shows a moderator station 10 with a control panel 700 shown physically at FIG. 10. The panel 700 helps to display timing, sequential questions, answer responses as entered by users of the devices 30, general information, is used for the selection of specific questions or the use of the projection display 40 or the presentation of the different elements of the presentation, displays multiple choice questions answers in charts or other forms, and display locations in answers where important zones of interest are found.

Generally speaking, the presentation software includes several modules, for example a question timing module 52, a team/user management module 51, a control panel module 50 that then all interface with a plurality of questions 53 where on the panel 700 each question is arranged sequentially as shown at FIG. 10 using a scroll bar 701 to help move from one question to the next 702, and where next to each question, a series of buttons or commands can be entered in the control panel 700, such as a button to display questions 57 on the display of the devices 30 or on the projection display 40, to display possible answers 56, to display user answers 55 as they are received by the software, or to display some type of data or info 54 associated with the question. While a handful of functions and buttons are disclosed, what is contemplated is the use of any type of command that allows for the management and better use of the system 100.

FIG. 6 shows using a block diagram of the different displays that will be seen and encountered by a user of a user device 30 as he/she is instructed by a moderator to log into the system and register. An address, such as an HTTP address is given to a user of a web-enabled device 30 and the site is reached. A website log-in page is shown 60 where a user is asked to confirm identity and/or enter any other information such as a relationship with a group or a team for a easier confirmation and allocation to a team 60. Once in the software, a home screen appears with different selections, for example, links and buttons can be offered 61 to direct to a list of players, a team description, a profile of user, a scoring page, a result page, or even to access to the main list of questions created by the system moderator. These questions can then be displayed in a subsequent screen 63.

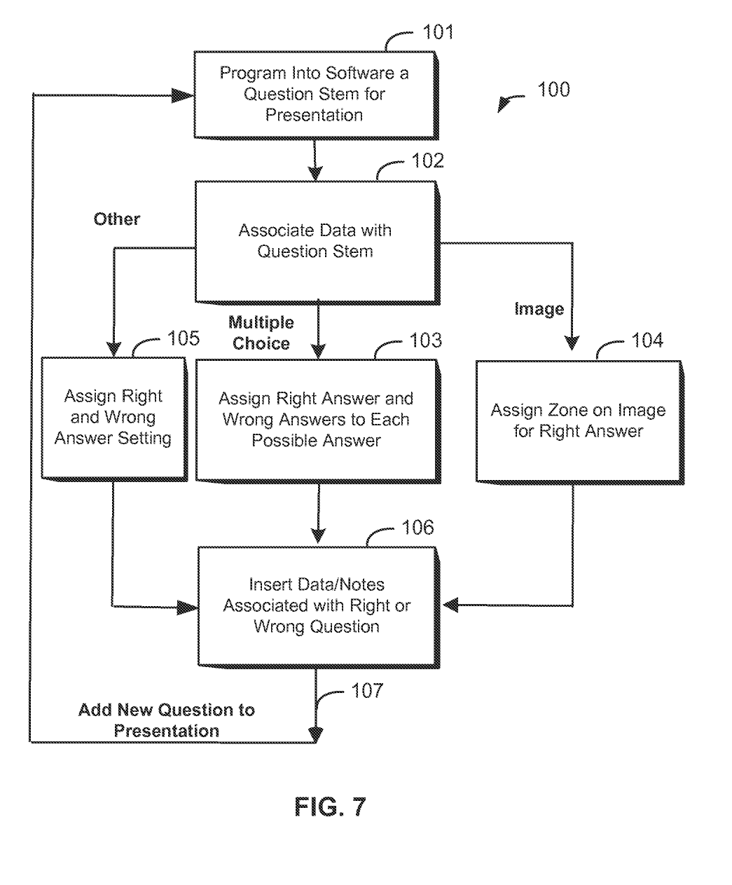

FIG. 7 shows as part of the software how each question 702 is entered into the software 101 including a stem of the question. Data is then associated 102 with the question stem, for example a series of multiple choices can be given, an image can be entered, a song, or any other piece of data. Based on the type of stem entered, if the question is a multiple choice, then a right answer and wrong answer value is given to each possible answer 103. If the question is an image, for example an X-Ray image, then a zone on the image is assigned 104 for a right answer to be entered on the devices 30 via a touch interface. If other types of questions or data is entered, then there is also a relevant way to assign a right and wrong setting 105 to each. In all three cases, notes can be inserted in a subsequent step 106 in associated with the right or wrong question. For example, if a question about the diagnostic of a X-Ray is shown and four different diagnostics are listed, if a student answers wrong, a teacher may have as inserted as data an X-Ray that shows each of the wrongful diagnostics associated with each of the wrong answers. At step 107, once a question is entered, a subsequent sequential question can be entered. In this system, immediate self-assessment can be conducted as the interface can be programmed to immediately display a red color on the screen if the answer is wrong so the student can wait for teacher instruction. In another embodiment, team scores are used on the display 40 to monitor the right/wrong answers, for example on the screen a team response could be 80% right at some point, prompting the students who have yet to answer to be extremely careful in their choice of answer.

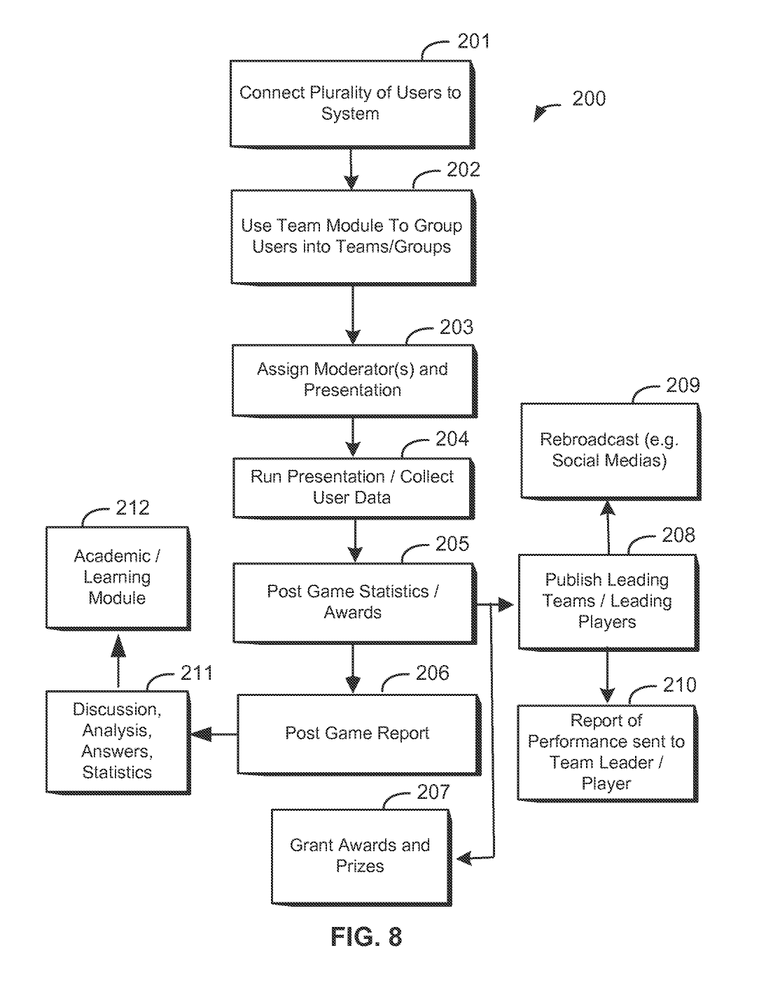

FIG. 8 illustrates how further motivation and energy/stimuli can be created by using the system 100 through a type of game incentive 200. Once a plurality of users 201 are connected to the system, these can be grouped into teams 202 or small user groups based on any type of attributes. For example, in a conference setting, a different team can be assigned to attendees with a similar employer, or a similar background. In a classroom setting, students can be assigned teams for lab projects and compete. After the presentation is assigned to the groups 203, the presentation and the questions associated with the question are then run 204. Data as to the answers for each user is then collected. In one embodiment, 10 points is awarded for a good answer and no point is awarded for a wrong or unanswered answer. While one type of incentive or point statistics determination system is shown, what is contemplated is any type of incentive that motivate individuals to compete in a friendly environment.

After the presentation has run 204 and questions have been answered 204, a post game report 206 is then issued. In one embodiment, it discusses and analyses results 211 along with giving personal and team statistics. In another embodiment, the report further includes an academic and learning module 212. For example, the discussion module 211 can illustrates that only 20% of doctors who responded to a question got the right diagnostic and that a majority instead answered a different answer. As part of the discussion, the reasons behind this error are analyzed and information is provided to help correct this mistake in yet another useful way to transfer information between individuals.

Finally, the statistics can also be given to the players in a friendly setting 208, for example on the display 40. The users can use their devices 30 to rebroadcast 209 to social media, such as Facebook™ their results. Finally, in case of need, for example if an employer sends a team of employee to a seminar, a report of performance 210 can be sent to players, team leaders, or back to employers for validation of participation as part of the seminar.

In one embodiment, the presentation software described and shown at FIGS. 5-6, and 10 is a web-enabled application running through web-portals of the devices connected via connection ports to the Internet or other networks. The presentation software 200 comprise a data entry module described at FIG. 7 for input of sequential questions as part of the general presentation where at least one question includes a stem 102, a right answer 103 or acceptable zone and at least a wrong answer or unacceptable zone. The software 200 at FIG. 5 also includes a team management module 51 for grouping a plurality of users into teams and for managing an incentive based program as described at FIG. 8. The software 200 further includes a class display module at a moderation station 10 for displaying at least a portion of each question 53 of the presentation, the stem 57, or an associated data 54 with each question over the projection display 40, and a user interface as shown at FIG. 6 for allowing a plurality of users to log-in 60 via the plurality of user devices 30, and where the interface displays a home screen 61 once each user identity is confirmed 62 and where the user interface then displays the series of sequential questions 63. The software 200 also includes a control panel module for display on the moderator interface as shown at FIG. 10, where the display for each of the sequential questions includes a button for the display of the question, a button for the display of many possible answers, and a button for the display of user responses 53 to 57. In another embodiment, what is contemplated is a web-based computer software in a computer memory of at least a computer processor connected to a network as described above.

In a final embodiment, what is also contemplated is a plurality of methods associated with the use of the software and computer system described above. For example, one method of transferring information from a moderator to a plurality of recipients in a face to face environment comprises the steps of entering into a web-based computer software using a web-enable interface a plurality of questions 101 to be displayed in a sequential order to a plurality of recipients in a face to face environment in a room, allowing a plurality of recipients to log into the web-based computer software 201 using their own user devices for the display of the plurality of questions, allowing a moderator to log into the web-based computer software using a moderator station as shown at FIG. 5, for the display of a moderator interface to control a transfer of information as shown at FIG. 10, and using the moderator interface to display portions of the plurality of questions on a room projection display 40 and on user interfaces of the user devices 30 in the room as illustrated in FIG. 3.

The method further includes the entry of a plurality of questions via the entry of the stem of a first question of a type 102, the first question type being selected from a group consisting of an image question, a multiple-choice question, and another type 103, 104, and 105, and if the first question is of the image type 104, assigning a zone on the image for the right answer, and inserting data associated with the first question, if the question is of the multiple-choice question type 103, assigning of a right answer and at least a wrong answer to the first question, and inserting of data associated with the first question, and if the question is of the other type 105, assigning of a right and a wrong answer, and inserting of data associated with the first question; and performance and repeat of the above steps for at least a second question.

Finally, the step of allowing the recipients to log into the web-based computer software as shown at FIG. 6 may include the steps of grouping users into teams 202, and awarding users of correct answers to the questions reward points 205, and calculating statistics for each user and each team, and ranking 206 each team in a post game report. Knowledge repositories can also be created where a student or recipient can keep track of the knowledge received over time, including different dynamic links to data that must be reviewed for further help with learning. For example, a seminar participant may be given access to a database where is indexed the different reports generated for the participant, information that has been provided over time, and links to information helpful for the participant. While one possible type of data bank is described, what is contemplated is the use of any type of data bank and associated access.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A computer system used between a moderator and a plurality of information recipients to aid with the transfer of information from the moderator to the recipients, the system comprising:
at least a moderator station comprising a moderator processor with a moderator memory, a moderator interface, and a moderator display each connected to the moderator processor for executing a control panel on the moderator display as part of a presentation software located on a remote server via a network, and for entry of at least a command via the moderator interface;
a projection display connected to the presentation software via the network for displaying a portion of a general presentation, wherein the portion displayed of the general presentation is controlled by the command entered in the moderator interface;
a plurality of user devices each with at least a user processor, a user memory connected to the user processor, a user interface, and a user display, wherein each device is connected to the presentation software for displaying information from the general presentation as controlled by the command entered in the moderator interface; and
at least one network enabled server connected to the network with a server processor and a server memory for executing the presentation software.

2. The computer system of claim 1, wherein the user display on the plurality of user devices is used to display at least a question from the general presentation, and wherein the user interface is used to enter a response to the at least a question.

3. The computer system of claim 2, wherein the network is the Internet, the moderator station is a portable computer.

4. The computer system of claim 1, wherein the user devices are selected from a group consisting of web-enabled phones, portable computers, fixed computers, and pads.

5. The computer system of claim 4, wherein the presentation software is a web-enabled application running through a web-portal for the connection via the Internet of the user devices, the control panel and the projection display.

6. The computer system of claim 1, wherein the projection display includes a computer with a processor connected thereto.

7. The computer system of claim 5, wherein the general presentation is formed by a plurality of successive questions related to radiology including multiple choice questions and image zone recognition.

8. The computer system of claim 1, wherein the presentation software comprise:
a data entry module for input of sequential questions as part of the general presentation, wherein at least one question includes a stem, a right answer or acceptable zone, and at least a wrong answer or unacceptable zone;
a team management module for grouping a plurality of users into teams and for managing an incentive based program;
a class display module for displaying at least a portion of each question of the presentation, the stem, or an associated data with each question over the projection display;
a user interface for allowing a plurality of users to log-in via the plurality of user devices, wherein the interface displays a home screen once each user identity is confirmed, and wherein the user interface then displays the series of sequential questions; and
a control panel module for display on the moderator interface, wherein the display for each of the sequential questions includes a button for the display of the question, a button for the display of many possible answers, and a button for the display of user responses.

9. A computer software in a computer memory of at least a computer processor connected to a network, the software programmed comprising:
a data entry module for entry of a series of sequential questions, wherein each question includes a stem, a designated right answer or acceptable zone, and a wrong answer or an unacceptable zone;
a team management module for grouping a plurality of users into teams and for managing an incentive based program from data received from a plurality of user devices;
a class display module for displaying at least a portion of each question, the stem, or an associated data with each question on a projection display;
a user interface for allowing a plurality of users to log-in via the plurality of user devices each with a browser over a network, wherein the interface displays a home screen once each user identity is confirmed, and wherein the user interface then displays the series of sequential questions once identity is confirmed; and
a control panel module for the display on a moderator station a moderator interface for the display for each a plurality of questions of the series of sequential questions, wherein the display for each of a plurality of questions on the moderator interface includes a button for the display of the question, a button for the display of many possible answers, and a button for the display of user responses.

10. The web-based computer software of claim 9, wherein the software further comprises a question timing module.

11. The computer software of claim 9, wherein each question further includes data associated with the question, and wherein the display further includes a button for the display of the data.

12. A method of transferring information from a moderator to a plurality of recipients in an environment using a computer system, the method comprises:
entering into a computer software using an interface a plurality of questions to be displayed in a sequential order to a plurality of recipients in a room;
allowing a plurality of recipients to log into the computer software using their own user devices for the display of the plurality of questions;
allowing a moderator to log into the computer software using a moderator station for the display of a moderator interface to control a transfer of information from the moderator to the plurality of recipients; and
using the moderator interface to display portions of the plurality of questions on a room projection display and on user interfaces of the user devices in the room, wherein the moderator interface includes.

13. The method of claim 12, wherein the computer software is a web-based computer software and the interface is a inch-based interface.

14. The method of claim 12, wherein the step of entry of a plurality of questions includes the steps of:
entry of the stem of a first question of a type, the first question type being selected from a group consisting of an image question, a multiple-choice question, and another type;
if the first question is of the image type, assigning a zone on the image for the right answer, and inserting data associated with the first question;
if the question is of the multiple-choice question type, assigning of a right answer and at least a wrong answer to the first question, and inserting of data associated with the first question;
if the question is of the other type, assigning of a right and a wrong answer, and inserting of data associated with the first question; and
performance and repeat of the above steps for at least a second question.

15. The method of claim 13, wherein the step of allowing the recipients to log into the web-based computer software, further comprises the steps of grouping users into teams, and wherein the step of using the moderator interface to display portions of the questions, includes the steps of:
awarding users of correct answers to the questions reward points;
calculating statistics for each user and each team; and
ranking each team in a post game report.

16. The method of claim 15, wherein the method further includes the step of publishing the statistics of each user and each team.

17. The method of claim 16, wherein the method further includes the step of allowing users to rebroadcast their own statistics over social medias.

18. The method of claim 14, wherein the post game report is sent to a team leader assigned by the software.

19. The method of claim 15, wherein the post game report includes data related to the presentation and the questions in the presentation from the group consisting of a discussion, an analysis, answers, and statistics.

20. The method of claim 19, wherein the post game report further includes information linked to an academic or learning module.
